(19) United States
(12) Patent Application Publication
(10) Pub. No.: US 2008/0258412 A1
(43) Pub. Date: Oct. 23, 2008

(54) Roll Regulation Actuator

(76) Inventor: Dirk Kesselgruber, Montabaur (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/660,665

(22) PCT Filed: Aug. 17, 2005
(86) PCT No.: PCT/EP05/08919

§ 371 Date: Apr. 21, 2008

(30) Foreign Application Priority Data
Aug. 19, 2004 (EP) 20 2004 013017.3

(51) Int. Cl. B60G 17/02

(52) U.S. Cl. 280/5.506

(57) ABSTRACT

A roll regulation actuator for installation between two axially aligned rods, in particular between two rods of a stabilizer, includes a cylindrical housing and a device arranged in the housing for providing a torque acting on at least one of the rods. The device includes a first piston displaceable in the housing with a first piston rod having a first thread. The device further includes a first ball nut rotatably mounted in the housing. The first ball nut engages the first piston rod via a first counter-thread matching the first thread, and is able to be coupled to one end of a first rod. The device further includes a first pressure chamber acting on a first side of the first piston.

### CROSS-REFERENCE TO RELATED APPLICATIONS

This application is a national stage of International Application No. PCT/EP2005/008919 filed Aug. 17, 2005, the disclosures of which are incorporated herein by reference, and which claimed priority to German Patent Application No. 20 2004 013 017.3 filed Aug. 19, 2004, the disclosures of which are incorporated herein by reference.

### BACKGROUND OF THE INVENTION

The invention relates to a roll regulation actuator for installation between two axially aligned rods, in particular between two rods of a stabilizer.

Such a roll regulation actuator including a cylindrical housing and a device arranged in the housing for providing a torque acting on at least one of the rods is known from British Patent Application GB 2 350 592 A. The actuator is used in roll regulation systems in which the stabilizer is divided into two rods which are respectively coupled to a wheel of the vehicle. When the vehicle is driving around bends, by means of the roll regulation actuator a torque can be produced between the two rods, which counteracts the forces introduced via the wheels, in order to thereby stabilize the vehicle.

### BRIEF SUMMARY OF THE INVENTION

It is an object of the invention to provide a roll regulation actuator which is more simply constructed and hence able to be produced at a more favourable price.

According to the invention, a roll regulation actuator for installation between two axially aligned rods, in particular between two rods of a stabilizer, comprises a cylindrical housing and a device arranged in the housing for providing a torque acting on at least one of the rods. The device comprises a first piston displaceable in the housing with a first piston rod having a first thread. The device further comprises a first ball nut rotatably mounted in the housing. The first ball nut engages the first piston rod via a first counter-thread matching the first thread, and is able to be coupled to one end of a first one of the rods. The device further comprises a first pressure chamber acting on a first side of the first piston. This construction makes provision, with a few simple components, for a conversion of a linear movement, generated by pressure, into a rotary movement, so that a torque acting between two stabilizer rods can be provided in an efficient manner.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a diagrammatic sectional view of a roll regulation actuator according to the invention in accordance with a first embodiment; and

FIG. 2 shows a diagrammatic sectional view of a roll regulation actuator according to the invention in accordance with a second embodiment.

### DETAILED DESCRIPTION OF THE INVENTION

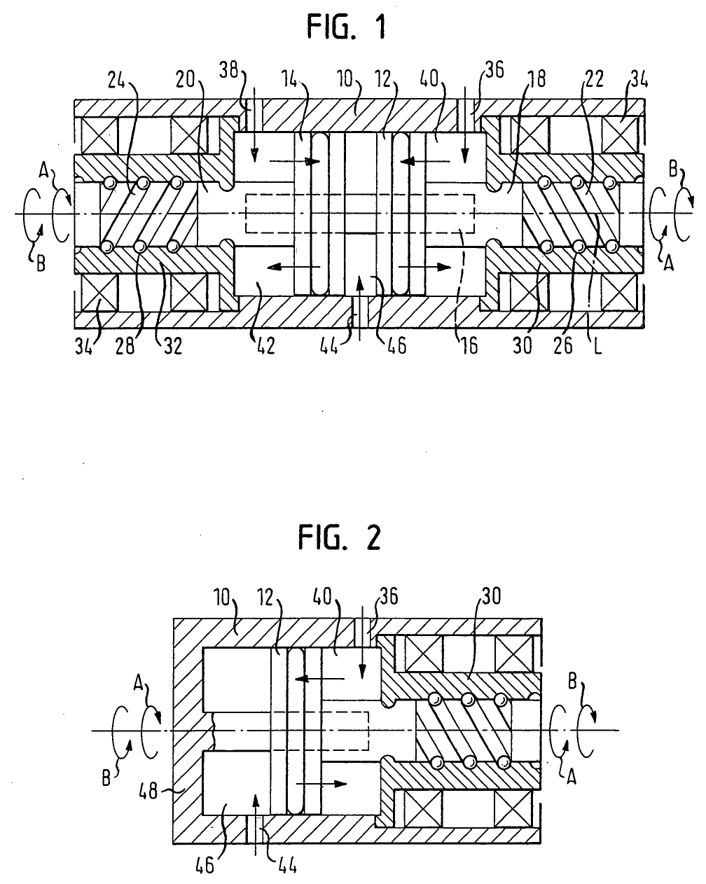

In FIG. 1 a roll regulation actuator is shown, which is provided for installation between two axially aligned rods of a stabilizer (not shown). The roll regulation actuator comprises a cylindrical housing 10, in which two pistons 12, 14 are held so as to be longitudinally displaceable. The pistons 12, 14 are arranged in a sliding manner on a guide rod 16, which counteracts a rotation of the pistons 12, 14 relative to the housing 10. On the sides of the pistons 12, 14 facing away from each other, piston rods 18, 20 are formed, which are provided with threads 22, 24. The threads 22, 24 have oppositely directed pitches with respect to the longitudinal axis L of the housing 10 and engage into counter-threads 26, 28 of ball nuts 30, 32, which are arranged rotatably by means of suitable bearings 34 in the housing 10, but non-displaceably in axial direction. The ball nuts 30, 32 are coupled respectively to one end of a stabilizer rod.

In the housing, two fluid connections 36, 38 are provided, which open into a first pressure chamber 40 formed between the first piston 12 and the first ball nut 30 and into a second pressure chamber 42 formed between the second piston 14 and the second ball nut 32, respectively. A further fluid connection 44 opens into a central pressure chamber 46, which is formed between the two pistons 12, 14. The pressure chambers 40, 42, 46 are sealed by sealing rings.

If pressure is built up via the two fluid connections 36, 38 in the two pressure chambers 40, 42, the two pistons 12, 14 move linearly towards each other. The guide rod 16 makes provision that the movement of the pistons 12, 14 is substantially free of rotation with respect to the axis L. The ball nuts 30, 32 arranged non-displaceably in axial direction, convert the linear movement of the pistons 12, 14 into rotary movements, the directions of which are marked by the arrows A. The rotation directions A of the ball nuts 30, 32 are oppositely directed owing to their different thread pitches.

A rotation of the ball nuts 30, 32 in the direction of the arrows B is achieved by a pressure build-up in the central pressure chamber 46 via the further fluid connection 44. In this case, the pistons 12, 14 move apart from each other linearly, and the ball nuts 30, 32 are rotated in opposition to the arrows A.

In the installed state, i.e. when the ball nuts 30, 32 are coupled with the opposite ends of two axially aligned stabilizer rods, a torque can be exerted between the rods, which counteracts the forces introduced via the wheels when the vehicle drives around a bend.

FIG. 2 shows an alternative embodiment of the roll regulation actuator, in which only one piston 12 and only one ball nut 30 are provided. As in the embodiment previously described, a first pressure chamber 40 able to be filled via a first fluid connection 18 is formed between the piston 12 and the ball nut 30. On the side of the piston 12 facing away from the ball nut 30, a further pressure chamber 46 is formed, which is able to be filled via the further fluid connection 44. The further pressure chamber 46 is delimited by a housing wall 48 on the end face, onto which one of the stabilizer rods can be coupled. By pressure build-up in the first pressure chamber 40, a torque is generated which in the non-stressed state of the roll regulation actuator would lead to a relative rotation between the ball nut 30 and the housing 10 in the direction of the arrows A. An opposite torque is achieved through a pressure build-up in the further pressure chamber 46.

The embodiment shown in FIG. 2 can in fact only provide a smaller torque compared with the embodiment shown in FIG. 1, but has a substantially more compact type of construction and is able to be produced at a more favourable cost owing to the reduced number of components.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A roll regulation actuator for installation between two axially aligned rods, in particular between two rods of a stabilizer, the actuator comprising
a cylindrical housing, and
a device arranged in the housing for providing a torque acting on at least one of the rods,
the device comprising
a first piston displaceable in the housing with a first piston rod having a first thread,
a first ball nut rotatably mounted in the housing, the first ball nut engaging the first piston rod via a first counter-thread matching the first thread, and being able to be coupled to one end of the first piston rod, and
a first pressure chamber acting on a first side of the first piston.

2. The roll regulation actuator according to claim 1, wherein the device comprises a second pressure chamber acting on the second side of the piston opposed to the first side.

3. The roll regulation actuator according to claim 1, wherein the first piston is arranged in a sliding manner on a guide rod, which counteracts a rotation of the piston relative to the housing.

4. The roll regulation actuator according to claim 1, wherein the device further comprises
a second piston displaceable in the housing, with a second piston rod having a second thread,
a second ball nut rotatably mounted in the housing, the second ball nut engaging the second piston rod via a second counter-thread matching the second thread, and being able to be coupled to an end of the second piston rod, and
a second pressure chamber acting on a first side of the second piston.

5. The roll regulation actuator according to claim 4, wherein the device comprises a second pressure chamber formed between the first and second pistons.

6. The roll regulation actuator according to claim 4, wherein the first and second pistons are arranged in a sliding manner on a guide rod, which counteracts a rotation of the pistons relative to the housing.
